(19) United States
(12) Patent Application Publication
(10) Pub. No.: US 2022/0351274 A1
(43) Pub. Date: Nov. 3, 2022

(54) MERCHANDISE ORDER RECEIVING SYSTEM

(71) Applicant: FABRIC TOKYO INC., Tokyo (JP)

(72) Inventor: Yuichiro MORI, Tokyo (JP)

(21) Appl. No.: 17/774,205

(22) PCT Filed: Nov. 13, 2019
(86) PCT No.: PCT/JP2019/044600

§ 371 Date: May 4, 2022

(51) Int. Cl. G06Q 30/06

(52) U.S. Cl. CPC G06Q 30/0633; G06Q 30/0627; G06Q 30/0629; G06Q 30/0621

(57) ABSTRACT

An order for merchandise that matches a user's size and preference can be received. An order input part configured to receive an order for fashion merchandise from a user; a search part configured to acquire design information including information about at least one of a fabric, a color, or a shape of the merchandise based on the order, configured to read size information of the user, and configured to acquire pattern information indicating a pattern of the merchandise that matches the size information; a user data acquisition part configured to acquire user data related to the user; and a correction part configured to make a correction on at least one of the design information or the pattern information of the merchandise in accordance with the user data are included.

### TECHNICAL FIELD

The present invention relates to a merchandise order receiving system.

### BACKGROUND ART

The size of a user's body is measured, and merchandise that matches the size is searched for.

### CITATION LIST

### Patent Literature

Patent Literature 1: JP 2018-141717 A

### SUMMARY OF INVENTION

### Technical Problem

The shapes of user's bodies present infinite variety, and it is impossible to prepare merchandise of all sizes beforehand.

The present invention has been made in view of such circumstances, and has an object to provide a technique capable of receiving an order for merchandise that matches a user's size and preferences.

### Solution to Problem

In order to address the above issue, a main invention of the present invention includes an order input part configured to receive an order for fashion merchandise from a user; a search part configured to acquire design information including information about at least one of a fabric, a color, or a shape of the merchandise based on the order, configured to read size information of the user, and configured to acquire pattern information indicating a pattern of the merchandise that matches the size information; a user data acquisition part configured to acquire user data related to the user; and a correction part configured to correct at least one of the design information or the pattern information of the merchandise in accordance with the user data.

Other issues disclosed in the present application and methods for addressing such issues will be clarified through the contents and drawings in embodiments of the present invention.

### Advantageous Effects of Invention

According to the present invention, an order for merchandise that matches a user's size and preferences can be received.

### BRIEF DESCRIPTION OF DRAWINGS

FIG. 1 is a diagram illustrating an overall configuration example of a merchandise order receiving system according to the present embodiment.

FIG. 2 is a diagram illustrating a hardware configuration example of a server apparatus 2.

FIG. 3 is a diagram illustrating a software configuration example of the server apparatus 2.

FIG. 4 is a diagram illustrating a configuration example of design information stored in a design information storage part 230.

FIG. 5 is a diagram illustrating a configuration example of pattern information stored in a pattern information storage part 231.

FIG. 6 is a diagram illustrating a configuration example of size information stored in a size information storage part 232.

FIG. 7 is a diagram illustrating a configuration example of basic information stored in a basic information storage part 233.

FIG. 8 is a diagram illustrating a configuration example of preference information stored in a preference information storage part 234.

FIG. 9 is a diagram illustrating a configuration example of correction information stored in a correction information storage part 235.

FIG. 10 is a diagram illustrating a configuration example of merchandise information stored in a merchandise information storage part 236.

FIG. 11 is a diagram illustrating a configuration example of a user's purchase history stored in a purchase history storage part 237.

FIG. 12 is a diagram illustrating a configuration example of a user's wearing history stored in a wearing history storage part 238.

FIG. 13 is a diagram for describing an operation of the merchandise order receiving system in the present embodiment.

### DESCRIPTION OF EMBODIMENTS

The contents of embodiments of the present invention will be listed and described. An embodiment of the present invention has a following configuration.
[Item 1]

A merchandise order receiving system including:

an order input part configured to receive an order for fashion merchandise from a user;

a search part configured to acquire design information including information about at least one of a fabric, a color, or a shape of the merchandise based on the order, configured to read size information of the user, and configured to acquire pattern information indicating a pattern of the merchandise that matches the size information;

a user data acquisition part configured to acquire user data related to the user; and

a correction part configured to make a correction on at least one of the design information or the pattern information of the merchandise in accordance with the user data.
[Item 2]

The merchandise order receiving system described in Item 1, further including

a correction information storage part in which a correction target item in either the design information or the pattern information and a correction value indicating a content of the correction are registered for every item value included in the user data, in which

the correction part reads the correction target item and the correction value from the correction information storage part, based on the user data, and makes the correction on at least one of the design information or the pattern information of the merchandise.
[Item 3]

The merchandise order receiving system described in Item 1 or 2, in which

the user data includes an item related to a job of the user, and

the correction part makes the correction based on an item value of the item related to the job of the user.
[Item 4]

The merchandise order receiving system described in any one of Items 1 to 3, in which

the user data includes an item related to a moving means used by the user, and

the correction part makes the correction based on an item value of the item related to the moving means used by the user.
[Item 5]

The merchandise order receiving system described in any one of Items 1 to 4, in which

the user data includes an item related to a habit of a posture of the user, and

the correction part makes the correction based on an item value of the item related to the habit of the posture of the user.
[Item 6]

The merchandise order receiving system described in any one of Items 1 to 5, in which

the user data includes an item related to a hobby of the user, and

the correction part makes the correction based on an item value of the item related to the hobby of the user.
[Item 7]

The merchandise order receiving system described in any one of Items 1 to 6, in which

the user data includes an item related to a preference for a size feeling of the user, and

the correction part makes the correction based on an item value of the item related to the preference for the size feeling of the user.
[Item 8]

The merchandise order receiving system described in any one of Items 1 to 7, in which

the user data includes weighting information indicating a priority for every item, and

the correction part makes the correction based on an item having a high priority with the weighting information out of items included in the user data.
[Item 9]

The merchandise order receiving system described in any one of Items 1 to 8, in which

the correction part further makes the correction based on a correction instruction that has been input by the user.
[Item 10]

The merchandise order receiving system described in any one of Items 1 to 9, further including

a merchandise information storage part configured to store a modification instruction for the merchandise that has been purchased by the user in a past, in which

the correction part makes the correction in response to the modification instruction.
[Item 11]

The merchandise order receiving system described in any one of Items 1 to 10, further including

a narrowing part configured to narrow down the design information and/or the pattern information that has been acquired by the search part to a predetermined number or less.
[Item 12]

The merchandise order receiving system described in Item 11, in which

the narrowing part narrows down the design information and/or the pattern information to a predetermined number or less in accordance with the user data.
[Item 13]

The merchandise order receiving system described in Item 11 or 12, further including

a purchase history storage part configured to store a purchase history including information about the merchandise that has been purchased by the user in a past, in which

the narrowing part narrows down the design information and/or the pattern information to a predetermined number or less in accordance with the purchase history.
[Item 14]

The merchandise order receiving system described in Item 13, in which

the purchase history includes feedback information of the user with respect to the merchandise, and

the narrowing part narrows down the design information and/or the pattern information to a predetermined number or less, based on the feedback information.
[Item 15]

The merchandise order receiving system described in Item 14, in which

the narrowing part selects and narrows down to the design information and/or the pattern information having a feature common to the merchandise with a positive content in the feedback information from the merchandise that has been purchased in the past.
[Item 16]

The merchandise order receiving system described in any one of Items 11 or 15, further including

a wearing history storage part configured to store either the number of wearing times or a wearing frequency for every piece of the merchandise owned by the user, in which

the narrowing part narrows down the design information and/or the pattern information to a predetermined number or less in accordance with either the number of wearing times or the wearing frequency.
[Item 17]

The merchandise order receiving system described in Item 16, in which

the narrowing part selects and narrows down the design information and/or the pattern information having a feature common to the merchandise that is either large in the number of wearing times or high in the wearing frequency from the merchandise that has been purchased in the past.
[Item 18]

The merchandise order receiving system described in any one of Items 1 to 17, in which

the search part acquires a plurality of pieces of the design information and/or the pattern information,

the correction part makes the correction on the plurality of pieces of the design information and/or the pattern information, and

the merchandise order receiving system further includes a merchandise presentation part configured to present a plurality of pieces of merchandise information to the user.
[Item 19]

The merchandise order receiving system described in any one of Items 1 to 18, further including:

a merchandise presentation part configured to present, to the user, merchandise information including the design information and/or the pattern information that has been corrected;

an order reception part configured to receive an order for the merchandise from the user; and

a manufacturing instruction part configured to transmit order reception information including the design information and/or the pattern information that has been corrected to a manufacturer of the merchandise.

### Overview

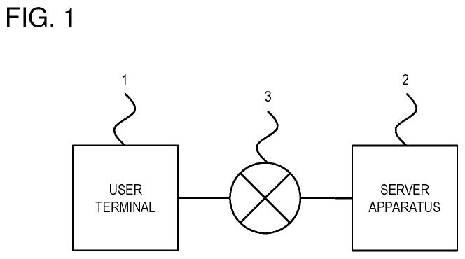

Hereinafter, a merchandise order receiving system according to an embodiment of the present invention will be described. FIG. 1 is a diagram illustrating an overall configuration example of the merchandise order receiving system according to the present embodiment. The merchandise order receiving system in the present embodiment includes a user terminal 1 and a server apparatus 2, and the user terminal 1 and the server apparatus 2 are communicably connected with each other through a communication network 3. The communication network 3 is, for example, the Internet, and is constructed with a public telephone network, a mobile telephone network, a wireless communication path, Ethernet (registered trademark), or the like.

The merchandise order receiving system in the present embodiment is a system that receives orders for fashion items. The fashion items in the present invention mean items worn on the body, and includes clothing, hats, gloves, shoes, and the like. Hereinafter, particularly, clothing will be described as an example. In the merchandise order receiving system in the present invention, an input of a size or a preference is received from a user, a pattern that matches the size or the preference is selected, and a design or the pattern is corrected in accordance with a user's preference. Accordingly, it becomes possible to provide the clothing suitable for the user's preference, as compared with a conventional pattern order.

### User Terminal 1

The user terminal 1 is a computer operated by a user. The user terminal 1 is, for example, a smartphone, a tablet computer, a personal computer, or the like. A user is able to access the server apparatus 2 through, for example, a web browser executed on the user terminal 1.

### Server Apparatus 2

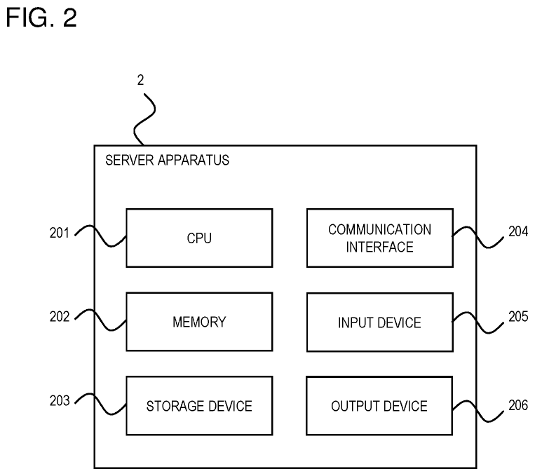

FIG. 2 is a diagram illustrating a hardware configuration example of the server apparatus 2. Note that the illustrated configuration is an example, and any other configuration may be included. The server apparatus 2 includes a CPU 201, a memory 202, a storage device 203, a communication interface 204, an input device 205, and an output device 206. The storage device 203 is, for example, a hard disk drive, a solid state drive, a flash memory, or the like that stores various types of data and programs. The communication interface 204 is an interface for connecting to the communication network 3, and is, for example, an adapter for connecting to Ethernet (registered trademark), a modem for connecting to a public telephone line network, a wireless communication device for conducting wireless communication, a universal serial bus (USB) connector for serial communication, an RS232C connector, or the like. The input device 205 is, for example, a keyboard, a mouse, a touch panel, a button, a microphone, or the like to input data. The output device 206 is, for example, a display, a printer, a speaker, or the like that outputs data.

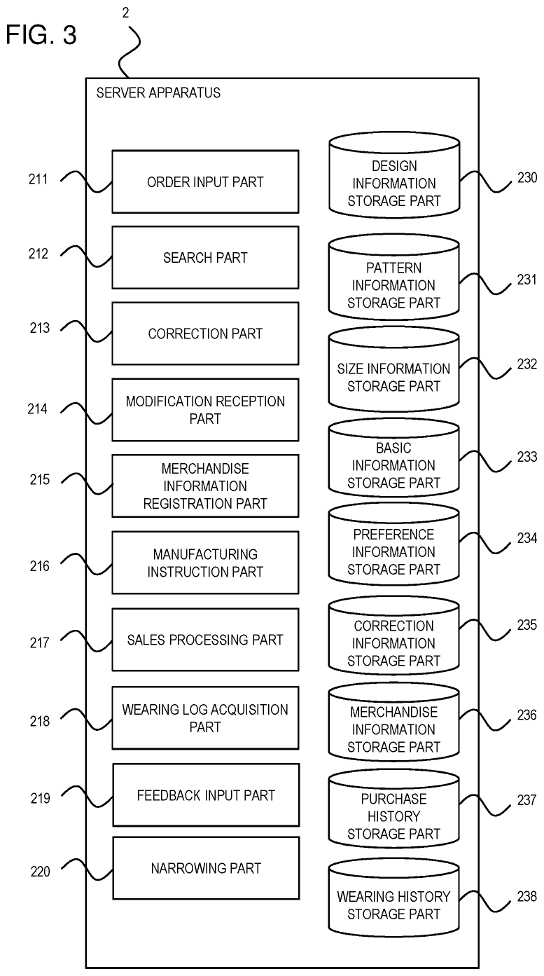

FIG. 3 is a diagram illustrating a software configuration example of the server apparatus 2. As illustrated in the drawing, the server apparatus 2 includes functional parts of an order input part 211, a search part 212, a correction part 213, a modification reception part 214, a merchandise information registration part 215, a manufacturing instruction part 216, a sales processing part 217, a wearing log acquisition part 218, a feedback reception part 219, and a narrowing part 220, and storage parts of a design information storage part 230, a pattern information storage part 231, a size information storage part 232, a basic information storage part 233, a preference information storage part 234, a correction information storage part 235, a merchandise information storage part 236, a purchase history storage part 237, and a wearing history storage part 238.

Note that each of the above-described functional parts is implemented by the CPU 201 included in the server apparatus 2 reading a program stored in the storage device 203 into the memory 202 and executing the program, and each of the above-described storage parts is implemented as a part of the memory 202 included in the server apparatus 2 and a storage area provided by the storage device 203.

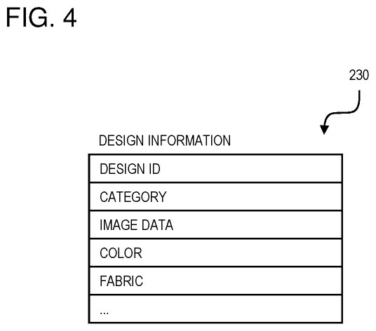

The design information storage part 230 stores data indicating a design of clothing (hereinafter, referred to as design information). FIG. 4 is a diagram illustrating a configuration example of design information stored in the design information storage part 230. The design information includes information including any of a category of clothing, images of clothing and a model who wears the clothing, and at least a color, a fabric, or a shape of merchandise, in association with a design ID that identifies the design. Furthermore, information regarding a wearing scene (business, casual, formal, or the like) and a wearing season (all through the year, fall and winter, spring and summer, or the like) may be included. Here, the category refers to a type of fashion merchandise such as jackets, slacks, shirts, coats, and hats. It is possible to give an ID to a fabric or a color as necessary. In addition, regarding the design information, it is possible to give a feature of the design as tag information for every design ID. For example, it is possible to set optional tag information such as “casual”, “for business use”, “formal”, “dark color”, “bright color”, “luxurious feeling”, “classical”, “trend”, “neat impression”, and “easy to move”. It is desirable to correspond to items included in user's basic information and preference information to be described later.

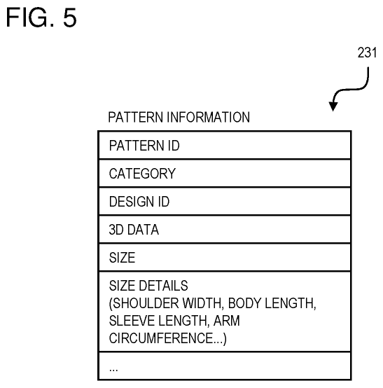

The pattern information storage part 231 stores data indicating a pattern of clothing (hereinafter, referred to as pattern information). In the present invention, the pattern information is information regarding a pattern for manufacturing a fashion item, and is prepared for every category or every design ID. FIG. 5 is a diagram illustrating a configuration example of pattern information stored in the pattern information storage part 231. The pattern information includes a category of clothing, a corresponding design ID, three-dimensional data (3D data) representing the pattern, a size (information indicating an outline of the size of the clothing such as S, M, or L), and details of the size (information indicating details or the size of a part of the clothing, such as a shoulder width, a body length, a sleeve length, and an arm circumference) in association with a pattern ID that identifies the pattern. Approximately several pieces to several hundreds of pieces of pattern information, which are size variations with different lengths of the respective parts, are set for one design ID. In addition, it is possible to set common pattern information for a plurality of design IDs, and in this case, a plurality of corresponding design IDs are included. To the pattern information, a feature of the pattern may be given as tag information for every pattern ID.

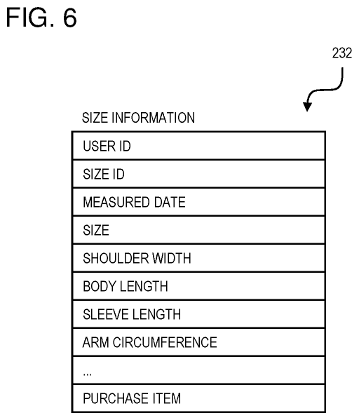

The size information storage part 232 stores information regarding a user's size (hereinafter, referred to as size information). FIG. 6 is a diagram illustrating a configuration example of size information stored in the size information storage part 232. The size information storage part 232 includes one or more pieces of size information, in association with a user ID that identifies a user. The size information includes a measured date and details of size, such as a shoulder width, a body length, a sleeve length, and an arm circumference, in association with the size ID. In addition, information regarding an item purchased in the past with the size information having been applied may be included. For example, in a case where the size measured for the first time on Mar. 30, 2013 is set to size ID=001, the size measured for the second time on Oct. 10, 2017 is set to size ID=002, and a jacket has been ordered with the size ID=002, information of a merchandise ID and the like of the purchased jacket is stored in association with the size ID.

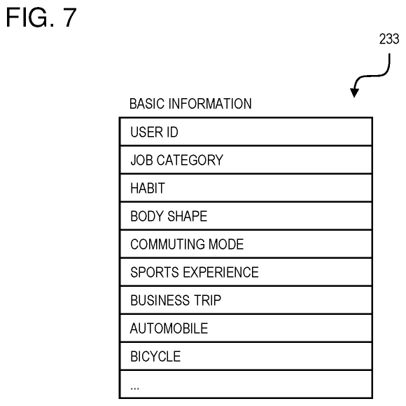

The basic information storage part 233 stores information regarding the user that can influence the size, design, function, or the like of clothing (hereinafter, referred to as basic information). FIG. 7 is a diagram illustrating a configuration example of the basic information stored in the basic information storage part 233. The basic information includes a user's job (a job category with a large amount of works while sitting, a sales job with a large amount of working outside, or a service business, a professional consultant, or the like), a habit of posture (slouch, inner shoulder, crossing legs, or the like), a frequently used transportation means (commuting mode (bicycle commuting, automobile commuting, or the like), a use frequency of an automobile or a bicycle, a business trip (the number of general business trips, the number of business trips on airplanes, the number of business trips on trains, or the like)), hobby (sports such as soccer, dance, and swimming, playing a musical instrument), and the like, in association with the user ID that identifies the user. When the user registers these items, the user is allowed to freely input the items, or may be allowed to select from preset options. It is possible to optionally give weighting information indicating a priority in narrowing, recommending, and correcting in each of these items. For example, the weighting information includes three stages of 1 to 3, and it is possible to appropriately set 3 to an important item desired to be particularly reflected in narrowing or correcting the merchandise, to set 1 to an item that does not have to be reflected so much, and to set 2 to an intermediate item. For example, in a case where the user desires to purchase an item while putting a high value on the item of “business trip”, it is possible to allow the user to set the weighting information “3” to the item of “business trip”. In a case where the user thinks that it is not necessary to particularly consider the item of “sports experience”, it is possible to allow the user to set the weighting information “1” to the item of “sports experience”.

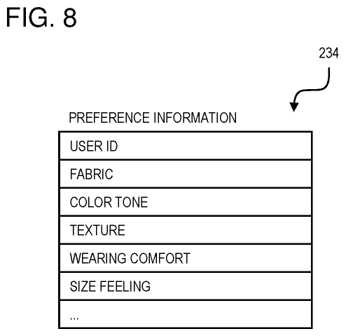

The preference information storage part 234 stores information (hereinafter, referred to as preference information) indicating user's preferences for fashion items. FIG. 8 is a diagram illustrating a configuration example of the preference information stored in the preference information storage part 234. In the preference information, information regarding preferences for tastes of fashion items such as a fabric, a color tone, a texture, a wearing comfort, and a size feeling are stored in association with a user ID that identifies the user. Here, as the “wearing comfort”, for example, putting a high value on the wearing comfort such as “easy to move”, “fit right on the body”, and “gentle to the skin” is registered. Further, as the size feeling, for example, a loose fit, a tight fit, or the like can be set. As the preference information, additionally, it is possible to appropriately set overall preferences and the like for fashion, such as whether to put a high value on a trend or a classical design, whether to prefer a characteristic design, whether to prefer an orthodox design, or the like. When the user registers these items, the user is allowed to freely input the items, or may be allowed to select from preset options. Further, it is possible to add weighting information to the preference information. For example, the weighting information includes three stages of 1 to 3, and it is possible to appropriately set 3 to an important item desired to be particularly reflected on the pattern of the merchandise, to set 1 to an item that does not have to be reflected so much, and to set 2 to an intermediate item.

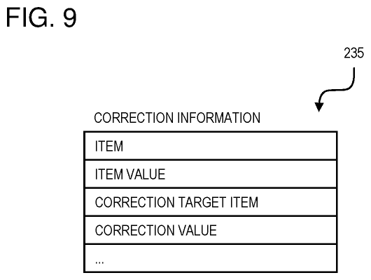

The correction information storage part 235 stores information indicating how to make a correction (hereinafter, referred to as correction information) in accordance with the basic information and the preference information. FIG. 9 is a diagram illustrating a configuration example of the correction information stored in the correction information storage part 235. The correction information includes an item included in the basic information or the preference information, a correction target (a pattern information, a fabric, a color, or the like) in association with its pair (an item value), and a correction value indicating how to correct the content of the correction target. In the present embodiment, it is assumed that the item is a single item, but a combination of a plurality of items may be set. It is also assumed that the correction item is a single correction item in the present embodiment, but a plurality of combinations may be set. It is possible to set a correction degree to the correction value for the content of the correction target.

For example, an example of correcting the pattern information based on the basic information will be described. In a case where an item value of “soccer” or “baseball” is set in the item of “hobby” of the basic information, the buttocks are large in many cases, and a silhouette looks fine in a tapered shape. Therefore, in the correction information, as the correction value for the correction target “pattern information”, it is possible to set a value to give a correction instruction to increase the buttocks by a given length and supplement the below-knee and bottom-opening widths. In addition, in a case where an item value of “wind instrument playing” is set in the item of “hobby”, the jacket is lifted up to the arms or the back is stretched in many cases. Therefore, as the correction value for the correction target “pattern information”, it is possible to set a value to give a correction instruction to lengthen the back width by a given length and reduce arm holes. Further, for example, in a case where an item value of “automobile commuting” is set in the item of “transportation means” in the basic information, the clothing having a shape that is easy to drive is desirable. Therefore, in the correction information, as the correction value for the correction target “pattern information”, it is possible to set the length of each part of the shoulder, the arm, the buttocks, and the thighs to be loosely fit (for example, in a case where a body shape pattern gradually increases in a stepwise manner to be loosely fit from pattern Y to pattern B, a value of how many degrees are increased may be set, the body shape pattern indicating the lowest degree to be loosely fit may be set, or a list of all body shape patterns appropriate for automobile driving may be set). Furthermore, for example, in a case where the item value of “slouch” is set in the item of “habit” in the basic information, it is possible to set the length of the shoulder to be loosely fit as the correction value of the correction target “pattern information” so that the shoulder part is not stretched. Moreover, in a case where the item value of the “office worker” is set in the item of “job” in the basic information, the sitting time is long, and the user takes a posture of placing the user's arms on the front side while doing desk work. Therefore, for the correction target “pattern information”, it is possible to give a correction instruction to increase the shoulder part by a given length so that the shoulder part is not stretched even when the shoulder moves to the front side, or to give a correction instruction to increase the waist by a given length. It is possible to set these pieces of correction information for each item included in the basic information.

In addition, regarding the correction information, it is possible to include a correction based on the preference information. For example, in a case where the item value of “tight fit” is set in the item of “size feeling” in the preference information, it is possible to set the shape pattern around the waist to be tightly fit, as the correction value of the correction target “pattern information” in the correction information, and to give a correction instruction to reduce the dimension around the waist by a given length, or a correction instruction to change to the pattern ID in which the dimension around the waist is set to be small. It is possible to set these pieces of correction information for another item such as the wearing comfort, in addition to the size feeling. The correction value of the correction target item “pattern information” as described above is preferably an instruction with which the pattern can be modified specifically. It is possible to register, for example, a correction instruction such as “+3 cm in the length” or “change to a pattern ID bigger by one size”.

The correction target is not limited to the pattern information, and a fabric, a color, and the like can also be set. For example, in a case where the item value of “bicycle commuting” is set in the item of “transportation means” in the basic information, a fabric that is strong against rubbing is desired. Therefore, it is possible to designate a fabric that is strong against rubbing (or to set a value indicating the strength of the fabric), as a correction value for the correction target “fabric” in the correction information. In this manner, the items of the basic information and the preference information, the correction target, and the correction content are stored in association with each other in the correction information, so that the correction in accordance with the basic information and the preference information can be made.

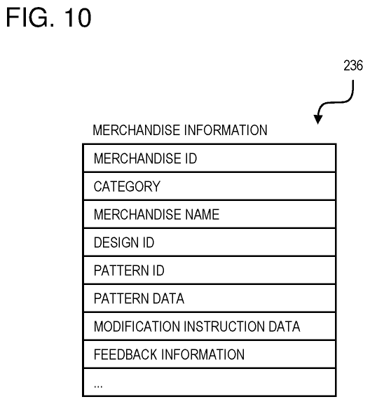

The merchandise information storage part 236 stores information regarding the clothing that has been finally presented to the user (hereinafter, referred to as merchandise information). FIG. 10 is a diagram illustrating a configuration example of the merchandise information stored in the merchandise information storage part 236. The merchandise information includes information such as a user ID of a purchaser, a delivery ID, a category of an item, a merchandise name, a design ID, a pattern ID, and pattern data after correction, in association with a merchandise ID that identifies the merchandise. In addition, it is possible to include modification instruction data in the merchandise information storage part 236. The modification instruction data includes a modification instruction that has been received from a user when the merchandise is presented to the user on the screen, a modification instruction (alteration) that has been received from the user after the merchandise had been delivered to the user, and the like. For example, a modification instruction to lengthen the sleeves by 1 cm, to shorten the waist by 1 cm, or the like is included. Further, as will be described later, the merchandise information storage part 236 stores feedback information from users. It is sufficient if the feedback includes the degree of satisfaction for the merchandise itself or the degree of satisfaction of each item such as a fabric, a color, a shape, and a size of the merchandise. It is sufficient if the feedback is represented by a numerical value obtained by converting a predetermined index into a numerical value or the like, or may be recorded in characters.

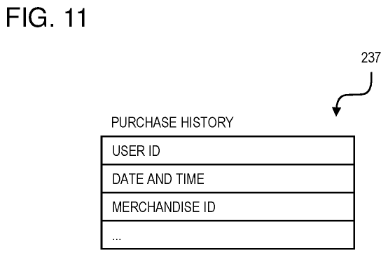

The purchase history storage part 237 stores a history of the clothing that has been purchased by the user. FIG. 11 is a diagram illustrating a configuration example of a user's purchase history stored in the purchase history storage part 237. The purchase history includes a user ID that identifies the user, a date and time when the user purchased the clothing, and a merchandise ID indicating merchandise information of the merchandise that has been purchased.

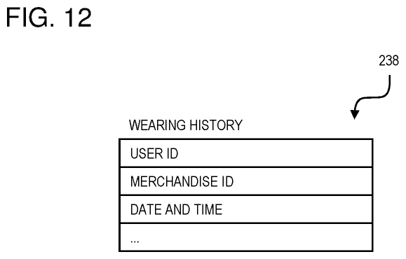

The wearing history storage part 238 stores a history of the clothing that has been worn by the user. FIG. 12 is a diagram illustrating a configuration example of a user's wearing history stored in the wearing history storage part 238. The wearing history includes a user ID that identifies the user, a date and time when the user worn the clothing, and a merchandise ID indicating merchandise information corresponding to the clothing that the user has worn. In the wearing history, it is possible to record the date and time when the user worn for every merchandise ID, and the number of wearing times in a latest given period (for example, one month, three months, or the like) may be calculated from the date and time when the user worn. As will be described later, regarding the wearing history of the clothing, for example, the user terminal 1 detects a tag or the like set to the clothing, and the user terminal 1 transmits the tag or the like to the server apparatus 2, so that the wearing history can be accumulated.

The order input part 211 receives an order for clothing from the user. At least a category of the clothing is set to the order.

The search part 212 searches for various types of information in accordance with the order. First, the search part 212 searches the design information storage part 230 for design information corresponding to the category set to the order. In this case, the design information that matches the category set to the order or that includes the category may be read. In addition, the search part 212 searches the size information storage part 232 for size data corresponding to the user ID indicating the user of an order source. In addition, when the size data to be used for the order of this time is determined, the search part 212 searches the pattern information storage part 231 for the pattern information that matches the details of the size of the size data. In this case, it is possible to search for the pattern information that matches the size data of the user in a known method. For example, with use of the details of the size in the size data of the user and the length of each item included in the pattern information, the distance between them is calculated, and the pattern information having the distance equal to or smaller than a predetermined threshold may be extracted.

The correction part 213 corrects the design or the size of the merchandise that has been determined in accordance with the user's order. The correction part 213 reads the correction information corresponding to the basic information and the preference information from the correction information storage part 235, and corrects the correction target included in the correction information in accordance with the correction value. In a case where the correction target item is “pattern information”, the length of each part in the size details of the pattern information is corrected in accordance with the instruction of the correction value. Alternatively, a correction may be made in a method for changing to a pattern ID larger (smaller) by one size. In a case where the correction target item is “fabric”, the fabric of the design information is changed in accordance with the correction value. In a case where a specific fabric is designated in the correction value, the fabric is changed to such a specified fabric. In addition, in a case where the material of the fabric (cotton, hemp, silk, or the like) or its ratio is designated in the correction value, the fabric is changed to the corresponding fabric. In a case where the correction target item is “color”, the color of the design information is changed in accordance with the correction value. In a case where a specific color is designated in the correction value, the color is changed to the specified color. In addition, a correction may be made in a method for changing to a color brighter (darker) by one tone.

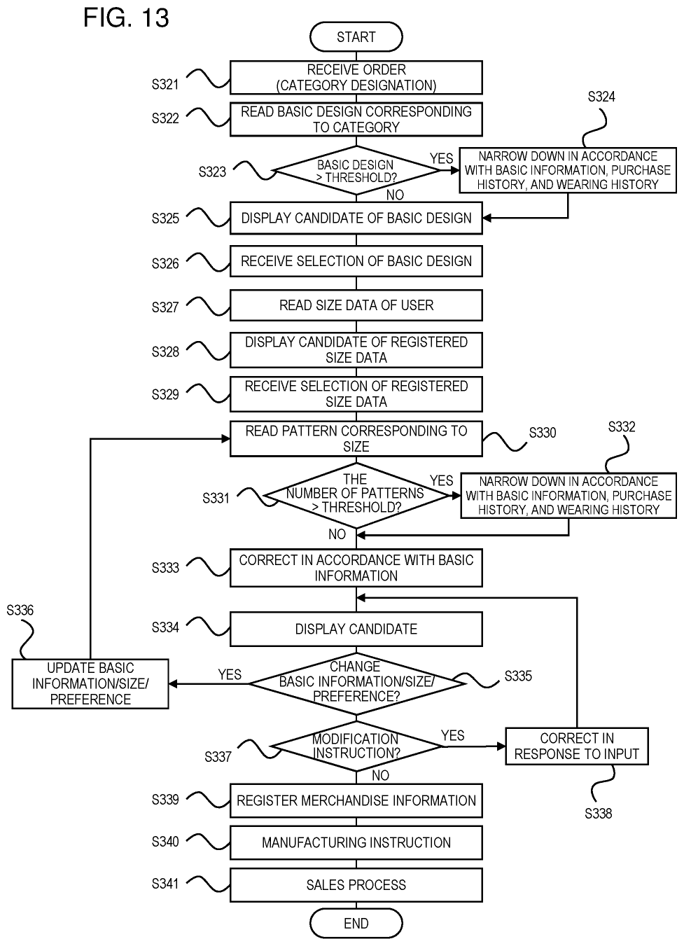

Further, the correction part 213 is capable of making a correction based on the modification instruction in the past. That is, the correction part 213 reads, from the information recorded in the merchandise information storage part 236, merchandise information that is a merchandise ID related to an order from the same user and that matches the order of this time in the same category. Then, in a case where the modification instruction data in the past is included in the merchandise information, the correction can be made based on the modification instruction data. The modification instruction data in the past includes a modification instruction made in step S337 in FIG. 13 to be described below and a modification instruction of a case where a request for an alteration is given after the merchandise is delivered for the user. For example, in a case where an order for a jacket has been received from a certain user, whether merchandise information having a category=“jacket” is present with regard to the user ID of the certain user is searched for in the merchandise information storage part 236, so the pattern ID and the modification instruction data=“lengthen the sleeves by 1 cm” when the user has ordered “jacket” in the past are read. Then, the correction part 213 reads the pattern ID that has been adopted from the merchandise information in the past, further reads the length of the sleeves from the pattern information storage part 231 based on the pattern ID, determines that the length obtained by further adding 1 cm to the length of the sleeves of the pattern ID is the length of the sleeves suitable for the user, and becomes capable of correcting the length of the sleeves of the jacket in the order of this time.

In a case where the correction based on the modification instruction in the past and the correction based on the basic information and the preference information relate to the same correction target, the correction part 213 is capable of selecting either one of the corrections in order of priority. Which correction the priority is given to may be set beforehand, and for example, the priority may be given to the correction based on the modification instruction in the past. In addition, which correction the priority is given to may be set for every correction target. For example, different settings can be made for every correction target, such that the priority is given to the correction based on the modification instruction in the past with regard to the correction to the pattern information or the priority is given to the correction based on the basic information and the preference information with regard to the correction to the fabric or the color. As an example, it is assumed that “tight fit” is set as the preference information of the size feeling, and the modification instruction data to lengthen the waist by 1 cm is recorded in the modification instruction in the past. In the correction information, in a case where the item value of the item “size feeling” is “tight fit” and the correction content to shorten the waist part by 2 cm is set for the correction target “pattern information”, the modification instruction in the past and the correction content in the preference information are not incident with each other. In this case, in a case where the priority is set to the correction based on the modification instruction in the past, the correction to lengthen the waist by 1 cm is made.

The order input part 211 presents, to the user, the merchandise information of the clothing that has been corrected by the correction part 213, and inquires the user of any designation of the merchandise information, whether to place an order for the clothing based on the pattern information, or whether to further modify the clothing.

The modification reception part 214 receives a modification instruction for the presented merchandise information from the user. Regarding the timing of receiving the modification instruction, after the correction part 213 presents a candidate of the corrected merchandise to the user, or when there is a request for an alteration after the merchandise has been delivered once, it is possible to receive the modification instruction with regard to the alteration. For example, the modification reception part 214 is capable of receiving, from the user terminal 1, a designation of the merchandise information, an item included in the merchandise information, and an instruction to modify the item. For example, it is possible to receive an instruction to “lengthen the sleeves by 1 cm” with regard to the item “pattern information”, an instruction to make “darker by one tone” with regard to the item “color”, and the like. There may be a plurality of sets of items and modification instructions.

The order input part 211 presents the pattern information that has been corrected by the correction part 213 to the user in response to the modification instruction, and inquires the user of whether to place an order for the clothing based on the pattern information or whether to further modify the clothing.

In a case where an order is placed for the clothing based on the merchandise information that has been modified in accordance with the modification instruction (or the merchandise information that has been corrected by the correction part 213, in a case where there is no modification instruction), the merchandise information registration part 215 creates merchandise information in which the delivery ID indicating the merchandise information, the value of each item of the merchandise information that has been finally corrected (design ID, pattern ID, or the like), the final pattern data, the correction data indicating the content that has been corrected (including items of the pattern information to be the correction target and its content), and the modification instruction data are set together with the user ID, and registers the merchandise information that has been created in the merchandise information storage part 236.

The manufacturing instruction part 216 instructs manufacturing of the clothing based on the merchandise information that has been ordered. For example, the manufacturing instruction part 216 is capable of transmitting the merchandise information to a computer of a factory to instruct the factory to manufacture the clothing.

The sales processing part 217 performs a process related to sales of the clothing. The sales processing part 217 is capable of performing, for example, a settlement process. Note that a general process related to the sales of the clothing by the sales processing part 217 is adoptable. When the sales process ends, the sales processing part 217 creates a purchase history including a user ID indicating a user of a sales customer, a date and time when sold, and a merchandise ID indicating merchandise information corresponding to the clothing that has been sold, and registers the purchase history in the purchase history storage part 237.

The wearing log acquisition part 218 detects that the clothing has been worn by the user, and registers a wearing history in the wearing history storage part 238. For example, a tag such as RFID or NFC may be embedded in the clothing, so that the user terminal 1 can detect the tag, record the wearing history, and transmit the wearing history to the server apparatus 2, and the wearing log acquisition part 218 can receive the wearing history. In addition, it is also possible to input a record indicating wearing of the clothing that has been worn by the user via an application service or the like.

Further, for example, the user may capture an image of either the user itself who wears the merchandise or the merchandise by using the camera included in the user terminal 1, the user terminal 1 may analyze the image that has been captured by the user terminal 1 to identify the merchandise and transmit a merchandise ID that has been identified to the server apparatus 2, so that the wearing log acquisition part 218 may receive the merchandise ID and register the wearing history. Furthermore, the user may capture an image of either the user itself who wears the merchandise or the merchandise by using the camera included in the user terminal 1, the user terminal 1 may transmit the image to the server apparatus 2, so that the wearing log acquisition part 218 may receive the image, analyze the image that has been received, identify the merchandise information corresponding to the clothing that is worn by the user and register the wearing history including the merchandise ID indicating the merchandise information that has been identified. In this case, it is possible to include the image obtained by capturing the clothing that has been manufactured based on the pattern information (or a feature amount of the clothing that has been extracted from the image) in the merchandise information to register the image, and it is possible to identify the clothing worn by the user in accordance with a similarity between the image that has been captured by the user and the image included in the merchandise information (or a matching degree between the feature amount that has been extracted from the image that had been captured by the user and the feature amount included in the merchandise information).

The feedback reception part 219 receives feedback from the user. Regarding the feedback, it is possible to receive impressions and evaluations for merchandise that has been purchased in the past, and corresponding information in the basic information storage part 233, the preference information storage part 234, and the merchandise information storage part 236 is updated and added as necessary. For example, regarding the merchandise that has been purchased in the past, a message of inquiring the user of impressions is transmitted after a lapse of a predetermined period from its delivery, so as to have the user input the impressions for the merchandise. As the inquiry items, for example, it is possible to appropriately set a plurality of items such as “how about the design?”, “how about the cloth?”, and “how about the size?”. As an example, the answer may include three degrees of 1 to 3, where “3” represents very good, “2” represents normal, and “1” represents not good. However, the answer is not limited to this, and a free answer may be used. On receipt of the answer from the user, the feedback reception part 219 records the answer in the data of the corresponding merchandise ID in the merchandise information storage part 236.

In a case where there are a plurality of design IDs or pattern IDs, the narrowing part 220 narrows down to a predetermined number or less, or recommends a specific one in accordance with a user's preference. First, when the search part 212 reads the design ID that matches the category included in the order, and in a case where the number of design IDs that match the category is equal to or larger than a predetermined number, the number of design IDs can be narrowed down to a predetermined number or less. The narrowing methods include a method to be performed based on the basic information and preference information, a method to be performed based on the purchase data in the past, and a method to be performed based on the wearing history in the past.

First, in the case of narrowing based on the basic information and preference information, items that can be used for narrowing are picked up from the items included in the basic information or the preference information. For example, in a case where “dark color” is set in the item of “color tone” in the preference information, it is possible to select a design ID having the “color” registered in the design information that corresponds to “dark color”. The determination as to whether or not the “color” registered in the design information matches the “dark color” may be made by deciding the kinds of color corresponding to the “dark color” beforehand, and may be made in accordance with an inclusion in it. Similarly, in a case where “luxurious feeling” is set in the item of “texture” in the preference information, it is possible to select one having the “fabric” registered in the design information that corresponds to “luxurious feeling”. The determination as to whether or not the “fabric” registered in the design information matches the “luxurious feeling” may be made by deciding the type of fabric corresponding to the “luxurious feeling” beforehand. In addition, regarding the above narrowing, the narrowing in this manner may be carried out by setting one or more pieces of tag information to the design information. For example, regarding a certain design ID, features that can be used for narrowing such as “luxurious feeling”, “for business use”, “dark color”, and “easy to move” are registered as tag information, so that a design ID having tag information that matches information of an item included in the basic information or the preference information can be selected. Furthermore, it is possible to select only a design ID having a predetermined number or more pieces of the tag information that matches the information of the items included in the basic information or the preference information.

In the case of narrowing based on the purchase data in the past, it is possible to select an item similar to or not similar to the item that has been purchased in the past by the user. First, a merchandise ID that has been purchased in the past is read from the purchase history storage part 237 of the user who has purchased in the past, and a design ID of the corresponding merchandise ID is read in the merchandise information storage part 236. In the case of selecting an item similar to the item that has been purchased in the past, it is possible to narrow down to a design ID having the same design ID with a design ID that has been purchased in the past, or a design ID having the same or similar features of the merchandise such as “color” or “fabric”. On the other hand, in a case where the merchandise that is not similar to the item that has been purchased in the past is intentionally selected, a design ID with a different “color” or “fabric” is selected.

Further, in a case of narrowing based on the purchase data in the past, it is also possible to use feedback information from the user. The feedback information includes a degree of satisfaction and an evaluation of the merchandise that have been obtained from the user after the merchandise is delivered to the user, and is stored in the merchandise information storage part 236 in association with the merchandise ID. The narrowing part 220 may read merchandise ID that has been purchased in the past from the purchase history storage part 237 in the past of the user, narrow down to an item similar to the merchandise in a case where the feedback information includes a good content, and conversely, narrow down to an item not similar to the merchandise in a case where the feedback information includes a not good content. For example, regarding the merchandise information of the merchandise that has been purchased in the past, in a case where the feedback indicating that the “fabric” is an unsatisfactory one is registered, the narrowing part 220 may identify the fabric used for the merchandise from the design ID included in the merchandise ID to exclude the design ID including such a fabric from a candidate for the basic design. In addition, regarding the merchandise for which the degree of satisfaction of the entire merchandise is highly evaluated, a design ID having a similar merchandise feature is selected. For example, it is possible to read tag information indicating a feature of the design from a design ID that has been used in the merchandise ID in the past to which a high evaluation has been given, and to select a design ID to which the same tag information with the tag information that has been read is added.

In a case of narrowing based on the wearing history in the past, it is possible to select an item similar to an item that is frequently worn by the user. First, the wearing history information having the user ID matched is read from the wearing history storage part 238 of the user, and the “frequently worn item” with a large number of wearing times or a high frequency is picked up. In picking up the “frequently worn item” with a large number of wearing times, as an example, a predetermined number of merchandise IDs may be selected as the “frequently worn item” in descending order of wearing times. In addition, as to the number of wearing times, it is possible to calculate the number of wearing times for a given period. Then, regarding the merchandise ID that has been picked up as the “frequently worn item”, a feature of the merchandise is read from the merchandise information storage part 236 or the design information storage part 230 so as to clarify the feature of the merchandise such as the “fabric”, “color tone”, and “texture”, and a design ID common to such a feature is selected. For example, in a case of narrowing the “fabric”, it is possible to read the type of the fabric used for the merchandise ID of the “frequently worn item” with a large number of wearing times, and to identify the type of the “fabric” with a large number of wearing times. Further, as described above, in a case where the feature of the merchandise is stored by being tagged to each design ID, it is possible to read the feature of the merchandise such as “luxurious feeling”, “for business use”, “dark color”, and “easy to move” added to the “frequently worn item” with a large number of wearing times from the tag information, and to select a design ID to which the same tag information is added.

As described above, the narrowing part 220 is capable of selecting an item in accordance with the user's preference, in a case where a predetermined number or more design IDs are hit. The narrowing part 220 is capable of narrowing down the design IDs to a predetermined number or less, and presenting the design IDs to the user. In addition, it is also possible to recommend the user as an item that particularly matches the user's preference. For example, one or several design IDs may be recommended together with a message like “this item is recommended to you”.

In addition, when the search part 212 searches for a pattern ID that matches the size data of the user, and in a case where a predetermined number or more pattern IDs are hit, the narrowing part 220 is capable of narrowing down to a predetermined number or less. The method for narrowing the pattern IDs include a method to be performed based on the basic information and preference information, a method to be performed based on the purchase data in the past, and a method to be performed based on the wearing history in the past.

First, in narrowing based on the basic information and preference information of the user, an item that can be used for narrowing the pattern ID is picked up from items included in the basic information or the preference information. For example, in a case where “loose fit” is registered in the item “size feeling” of the preference information, it is possible to preferentially select a pattern ID having a larger size from a plurality of pattern IDs.

Further, in the case of narrowing based on the purchase data in the past, it is possible to select data close to the pattern data that has been adopted in the items that have been purchased in the past by the user. In a case where a pattern ID same with the pattern ID that has been adopted in the item that had been purchased in the past is selectable, it is possible to select the same pattern ID, and furthermore, it is possible to narrow by appropriately selecting a pattern ID having a size close to the pattern ID. Also in this case, in a case where the feedback information is given to the merchandise that has been purchased in the past, it is possible to refer to the feedback information. That is, in a case where the degree of satisfaction of the entire merchandise or the degree of satisfaction regarding the size is good in the feedback information, it is possible to select the pattern ID that is the same with or close to the pattern data of the merchandise, and conversely, in a case where the degree of satisfaction is low, it is possible to exclude the pattern ID that is the same with or close to the pattern data of the merchandise from the candidates.

Further, in the case of narrowing based on the wearing history in the past, it is possible to select a pattern ID similar to the pattern ID that has been adopted for the item frequently worn by the user. First, the wearing history information having the user ID that matches is read from the wearing history storage part 238 of the user, and the “frequently worn item” with a large number of wearing times is picked up. Then, the pattern ID is read from the merchandise ID of the “frequently worn item”. In a case where a pattern ID same with such a pattern ID is selectable, it is possible to select the same pattern ID, and furthermore, it is possible to narrow by appropriately selecting a pattern ID having a size close to the pattern ID.

As described above, the narrowing part 220 is capable of narrowing down the pattern IDs to a predetermined number in accordance with the user's preference. In addition, one or several pattern IDs may be recommended together with a message like “this size is recommended to you” as the pattern ID that particularly matches the user's preference and an imaginary image when worn.

Further, after selection of the design ID and determination of the basic design, there may be a process of selecting detailed designs such as shapes and the number of collars, buttons, and pockets. For example, after determining the basic design of the jacket, the user selects either two buttons or three buttons. In selecting such a detailed design, the narrowing part 220 is capable of recommending the detailed design in accordance with the user's preference as described above. It is possible to make a recommendation based on the basic information and preference information of the user, the purchase history in the past, and the wearing history in the past.

First, in a case of making a recommendation based on the basic information and preference information of the user, the recommendation may be made by setting a detailed design to be recommended beforehand for the item value of each item such as “work” and “wearing comfort”. In addition, in a case of making a recommendation based on the purchase history in the past, it is possible to recommend a detailed design that is the same as the design that has been adopted in the purchase item in the past, or to intentionally recommend a different detailed design. For example, in a case where a jacket with “two buttons” has been purchased in the past, the same “two buttons” may be recommended, or “three buttons” may be recommended together with a message like “why don't you try three buttons this time?”.

Furthermore, in the case of making a recommendation based on the wearing history in the past, it is possible to recommend the detailed design that is adopted in the frequently worn item by picking up the “frequently worn item” and reading the detailed design adopted in these items in the same manner as described above.

FIG. 13 is a diagram for describing an operation of a merchandise order receiving system in the present embodiment.

The order input part 211 receives an order for a fashion item such as clothing from the user terminal 1 (S321). It is assumed that a user ID and a category of the clothing are set to the order. The search part 212 reads the design ID of the basic design that matches the category of the clothing included in the order (S322). In a case where the number of design IDs is equal to or larger than a predetermined number (S323), the narrowing part 220 narrows down the design IDs to a predetermined number or less, based on the basic information and preference information, the purchase history, the wearing history, and the like (S324). Then, image data or the like of a candidate of the basic design that has been read by the search part 212 or a candidate of the basic design to which the narrowing part 220 has further narrowed down is displayed on the user terminal (S325). The user selects an item that the user desires to purchase from a plurality of candidates of the basic design (S326).

In addition, a process of determining the design of the detailed parts with regard to the basic design may be provided. For example, in a case of purchasing a jacket, the respective candidates for the number of buttons, the shape of the collar, the shape of the pocket, and the like are displayed, and the user selects them. In this situation, in a case where the number of detailed design candidates is larger than a predetermined number, the narrowing part 220 may select the candidates to a predetermined number or less, or may recommend a specific design candidate from the candidates. The narrowing part 220 is capable of narrowing or recommending these items based on at least any of the basic information and preference information, the purchase history, and the wearing history.

Next, the size data of the user is read from the size information storage part 232 (S327). In a case where there are a plurality of pieces of size data (size IDs), a plurality of registered size data candidates are displayed on the user terminal (S328). In this situation, a measured date, information of an item that has been purchased using the size data, and the like are displayed together. The user selects size data (size ID) that the user desires to use this time from a plurality of pieces of size data (S329).

The search part 212 searches the pattern information storage part 231 for the pattern information corresponding to the design ID and size ID that have been selected (S330). For example, the search part 212 is capable of searching the pattern information for one having the design ID matched and having a predetermined number or more items with size details that match the size data included in the size ID of the user.

In a case where the number of pieces of the pattern information that has been searched for exceeds a predetermined threshold (S331), the narrowing part 220 reads the basic information and the preference information corresponding to the user ID respectively from the basic information storage part 233 and the preference information storage part 234, and narrows down the pattern information in accordance with the basic information and the preference information that have been read (S332). In the case of narrowing based on the basic information and the preference information, weighting information added to these pieces of information may be additionally considered. For example, regarding items that have been determined to be important by the weighting information, it is possible to narrow down to only the items that match. Furthermore, the search part 212 is capable of narrowing down the pattern information in accordance with the purchase history (S332). For example, the search part 212 is capable of picking up merchandise information that matches the category of the order from the merchandise information corresponding to the merchandise ID included in the purchase history corresponding to the user ID, and is capable of narrowing down the pattern information to a predetermined number or less in accordance with the matching degree of each item included in the pattern data (that is, the pattern information similar to the clothing that has been purchased in the past). Furthermore, the search part 212 is capable of narrowing down the pattern information in accordance with the wearing history (S332). For example, it is possible to pick up an item that matches the category of the order and that has a large number of wearing times and frequency from the merchandise information corresponding to the merchandise ID included in the wearing history corresponding to the user ID, and it is possible to narrow down the pattern information to a predetermined number or less in accordance with the matching degree of each item included in the pattern data (that is, the pattern information similar to a frequently worn item).

The correction part 213 corrects each of the design and the pattern that have been searched for, in accordance with the basic information and preference information corresponding to the user ID (S333). For example, using the correction information corresponding to the basic information and preference information, the correction part 213 is capable of correcting a correction target item included in the correction information, based on a correction value included in the correction information. In addition, the correction part 213 is capable of making a correction, based on the modification instruction that has been given by the user in the past. That is, it is possible to make a correction by referring to the modification instruction that has been given to the information that matches the category of the order, from the information recorded in the merchandise information storage part 236.

The order input part 211 creates screen data for presenting the design information and the pattern information that have been corrected by the correction part 213 to the user, and transmits the screen data to the user terminal 1, and the user terminal 1 presents the design information and the pattern information to the user (S334). Here, in a case where a change to at least any of the basic information, the preference information, and the size information is designated in the user terminal 1 (S335: YES), the order input part 211 receives the content of the change from the user terminal 1, updates at least any of the basic information, the size information, and the preference information (S336), and repeats the process from step S330.

In addition, in a case where the user terminal 1 receives a modification instruction with regard to the design and the pattern (for example, the instruction may be given such that the body length is slightly longer and the color is slightly lighter, or a value may be specified such that the fabric is changed to hemp) (S337: YES), the modification reception part 214 receives the modification instruction, and converts the modification instruction into a value to be correctable by the correction part 213, and the correction part 213 makes a correction in response to the modification instruction (S338), and repeats the process from step S334.

In a case where the merchandise is decided without a modification instruction (S337: NO), the merchandise information registration part 215 creates merchandise information in which the value (pattern data) of each item of the design ID, the original pattern ID, and the pattern information that has been finally corrected, and the correction data indicating the corrected content are set together with the merchandise ID and registered in the merchandise information storage part 236 (S339), the manufacturing instruction part 216 instructs to manufacture the clothing based on the merchandise information (S340), and the sales processing part 217 performs a sales process such as a settlement process related to the sales of the clothing (S341).

As described above, according to the merchandise order receiving system in the present embodiment, the pattern information that matches the user's size can be searched for, and the pattern can be corrected in accordance with the basic information and the preference information of the user, so that an order for the clothing that matches the user's size and preference can be received.

In addition, according to the merchandise order receiving system in the present embodiment, even in a case where a large number of pieces of pattern information is prepared, it is possible to narrow down in accordance with the size, the basic information, the preference, the purchase history, and the like of the user. Therefore, it is possible to avoid any confusion due to too many options when the user places an order.

Further, according to the merchandise order receiving system in the present embodiment, the user is able to finally modify the pattern that has been selected and corrected on the system side, it is possible to receive an order close to a full order with a pattern order used as a basis.

Although the present embodiment has been described above, the above embodiment is for facilitating the understanding of the present invention, and is not intended to limit the interpretation of the present invention. The present invention can be modified and improved without departing from the gist, and the present invention includes its equivalents.

For example, in the present embodiment, the server apparatus 2 is a single computer, without being limited to this, and the functional parts and the storage parts may be distributed to a plurality of computers. For example, each storage part of the server apparatus 2 may be included in a database server, and the server apparatus 2 may access the database server. Further, the respective functional parts can be provided in a distributed manner in a plurality of computers. For example, a computer including a functional part that transmits to and receives from the user terminal 1 and a computer including a functional part that does not transmit to or receive from the user terminal 1 may be provided individually, so that two computers may perform processes while communicating with each other.

In addition, the process of FIG. 13 illustrates an example of a process by the merchandise order receiving system in the present embodiment, and is not intended to limit the present invention. The steps included in the process of FIG. 13 may be executed in a different order from the order illustrated in FIG. 13, a part of the process may be executed in parallel, a part of the steps may be omitted, or another step may be added.

### REFERENCE SIGNS LIST

1 User terminal
2 Server apparatus
3 Communication network
211 Order input part
212 Search part
213 Correction part
214 Modification reception part
215 Merchandise information registration part
216 Manufacturing instruction part
217 Sales processing part
218 Wearing log acquisition part
219 Feedback reception part
220 Narrowing part
330 Design information storage part
231 Pattern information storage part
232 Size information storage part
233 Basic information storage part
234 Correction information storage part
235 Preference information storage part
236 Merchandise information storage part
237 Purchase history storage part
238 Wearing history storage part

1. A merchandise order receiving system comprising:
an order input part configured to receive an order for fashion merchandise from a user;
a search part configured to acquire design information including information about at least one of a fabric, a color, or a shape of the merchandise based on the order, configured to read size information of the user, and configured to acquire pattern information indicating a pattern of the merchandise that matches the size information;
a user data acquisition part configured to acquire user data related to the user; and
a correction part configured to make a correction on at least one of the design information or the pattern information of the merchandise in accordance with the user data, wherein
the user data includes weighting information indicating a priority for every item, and
the correction part makes the correction based on an item having a high priority with the weighting information out of items included in the user data.

2. The merchandise order receiving system according to claim 1, further comprising
a correction information storage part in which a correction target item in either the design information or the pattern information and a correction value indicating a content of the correction are registered for every item value included in the user data, wherein
the correction part reads the correction target item and the correction value from the correction information storage part, based on the user data, and makes the correction on at least one of the design information or the pattern information of the merchandise.

3. The merchandise order receiving system according to claim 1, wherein
the user data includes an item related to a job of the user, and
the correction part makes the correction based on an item value of the item related to the job of the user.

4. The merchandise order receiving system according to claim 1, wherein
the user data includes an item related to a moving means used by the user, and
the correction part makes the correction based on an item value of the item related to the moving means used by the user.

5. The merchandise order receiving system according to claim 1, wherein
the user data includes an item related to a habit of a posture of the user, and
the correction part makes the correction based on an item value of the item related to the habit of the posture of the user.

6. The merchandise order receiving system according to claim 1, wherein
the user data includes an item related to a hobby of the user, and
the correction part makes the correction based on an item value of the item related to the hobby of the user.

7. The merchandise order receiving system according to claim 1, wherein
the user data includes an item related to a preference for a size feeling of the user, and
the correction part makes the correction based on an item value of the item related to the preference for the size feeling of the user.

8. (canceled)

9. The merchandise order receiving system according to claim 1, wherein
the correction part further makes the correction based on a correction instruction that has been input by the user.

10. The merchandise order receiving system according to claim 1, further comprising
a merchandise information storage part configured to store a modification instruction for the merchandise that has been purchased by the user in a past, wherein
the correction part makes the correction in accordance with the modification instruction.

11. The merchandise order receiving system according to claim 1, further comprising
a narrowing part configured to narrow down the design information and/or the pattern information that has been acquired by the search part to a predetermined number or less.

12. The merchandise order receiving system according to claim 11, wherein
the narrowing part narrows down the design information and/or the pattern information to a predetermined number or less in accordance with the user data.

13. The merchandise order receiving system according to claim 11, further comprising
a purchase history storage part configured to store a purchase history including information about the merchandise that has been purchased by the user in a past, wherein
the narrowing part narrows down the design information and/or the pattern information to a predetermined number or less in accordance with the purchase history.

14. The merchandise order receiving system according to claim 13, wherein
the purchase history includes feedback information of the user with respect to the merchandise, and
the narrowing part narrows down the design information and/or the pattern information to a predetermined number or less, based on the feedback information.

15. The merchandise order receiving system according to claim 14, wherein
the narrowing part selects and narrows down to the design information and/or the pattern information having a feature common to the merchandise with a positive content in the feedback information from the merchandise that has been purchased in the past.

16. The merchandise order receiving system according to claim 11, further comprising
a wearing history storage part configured to store either the number of wearing times or a wearing frequency for every piece of the merchandise owned by the user, wherein
the narrowing part narrows down the design information and/or the pattern information to a predetermined number or less in accordance with either the number of wearing times or the wearing frequency.

17. The merchandise order receiving system according to claim 16, wherein
the narrowing part selects and narrows down the design information and/or the pattern information having a feature common to the merchandise that is either large in the number of wearing times or high in the wearing frequency from the merchandise that has been purchased in the past.

18. The merchandise order receiving system according to claim 1, wherein
the search part acquires a plurality of pieces of the design information and/or the pattern information,
the correction part makes the correction on the plurality of pieces of the design information and/or the pattern information, and
the merchandise order receiving system further comprises a merchandise presentation part configured to present a plurality of pieces of merchandise information to the user.

19. The merchandise order receiving system according to claim 1, further comprising:
a merchandise presentation part configured to present, to the user, merchandise information including the design information and/or the pattern information that has been corrected;
an order reception part configured to receive an order for the merchandise from the user; and
a manufacturing instruction part configured to transmit order reception information including the corrected design information and/or the pattern information that has been corrected to a manufacturer of the merchandise.
